(19) United States
(12) Patent Application Publication
(10) Pub. No.: US 2026/0285349 A1
(43) Pub. Date: Sep. 24, 2026

(54) INFORMATION PROCESSING DEVICE, INFORMATION PROCESSING SYSTEM, INFORMATION PROCESSING METHOD, AND STORAGE MEDIUM

(71) Applicant: HONDA MOTOR CO., LTD., Tokyo (JP)

(72) Inventors: Ryuji Iwashita, Wako-shi (JP); Yuji Yasui, Wako-shi (JP); Masahiro Kimura, Wako-shi (JP); Yoko Umeyama, Tokyo (JP); Tetsuya Gomi, Tokyo (JP); Seungho Choi, Wako-shi (JP); Ryo Takebayashi, Tokyo (JP); Taiki Iwama, Tokyo (JP); Adil Gupta, Tokyo (JP); Kotaro Masuda, Wako-shi (JP); Jing Zhao, Tokyo (JP)

(21) Appl. No.: 19/550,096

(22) Filed: Feb. 25, 2026

(30) Foreign Application Priority Data
Mar. 24, 2025 (JP) 2025-048664

(51) Int. Cl. B60W 50/14; B60K 35/28; B60W 40/08; G06V 20/58; G06V 20/59; G06V 40/18

(52) U.S. Cl. CPC B60W 50/14; B60K 35/285; B60W 40/08; G06V 20/58; G06V 20/597; G06V 40/18; B60K 2360/178; B60K 2360/1868; B60K 2360/569; B60W 2040/0881; B60W 2050/143; B60W 2050/146; B60W 2420/403; B60W 2540/01; B60W 2540/215; B60W 2540/225; B60W 2554/4041; B60W 2556/10

(57) ABSTRACT

An information processing device includes a risk detection unit configured to detect a risk object positioned surrounding a vehicle, an alarm control unit configured to cause an alarm display unit provided in the vehicle to display an alarm according to a position of the risk object, an acquisition unit configured to acquire a face image of a driver of the vehicle, a recognition determination unit configured to determine whether the driver is able to recognize the alarm by the alarm display unit, on the basis of a position where the alarm is displayed and information relating to the face image, a storage control unit configured to store, in a storage unit, history information in which the position where the alarm is displayed, information about whether the driver is able to recognize the alarm, and a visual line detected from the face image are associated.

### CROSS-REFERENCE TO RELATED APPLICATION

Priority is claimed on Japanese Patent Application No. 2025-048664, filed Mar. 24, 2025, the content of which is incorporated herein by reference.

### BACKGROUND OF THE INVENTION

### Field of the Invention

The present invention relates to an information processing device, an information processing system, an information processing method, and a storage medium.

### Description of Related Art

In recent years, efforts have been actively made to provide access to a sustainable transportation system with special attention to people in vulnerable situations such as aged people, people with disabilities, and children among traffic participants. To implement this, research and development for further improving the safety or convenience of traffic through development regarding means for transportation for, in particular, aged people or people with disabilities has been focused on (for example, see Patent Document 1 described below).

[Patent Document 1] Japanese Unexamined Patent Application, First Publication No. 2021-144505

### SUMMARY OF THE INVENTION

When a driver is suffering from visual field narrowing (visual field loss), a driver's ability to avoid a risk object is reduced. However, the driver may be unaware of visual field narrowing. When the driver continues driving while being unaware of visual field narrowing and reduction in ability due to visual field narrowing, there is a possibility that the safety or convenience of traffic is impaired.

An aspect according to the present invention has been made in consideration of such a situation, and an object of the present invention is to provide an information processing device, an information processing system, an information processing method, and a storage medium capable of detecting visual field narrowing of a driver. The present invention, in turn, contributes to development of a sustainable transportation system.

To solve the above-described problem, the present invention employs the following aspects.
(1) An information processing device according to an aspect of the present invention includes a risk detection unit configured to detect a risk object positioned surrounding a vehicle, an alarm control unit configured to cause an alarm display unit provided in the vehicle to display an alarm according to a position of the risk object, an acquisition unit configured to acquire a face image of a driver of the vehicle, a recognition determination unit configured to determine whether the driver is able to recognize the alarm by the alarm display unit, on the basis of a position where the alarm is displayed and information relating to the face image, a storage control unit configured to store, in a storage unit, history information in which the position where the alarm is displayed, information about whether the driver is able to recognize the alarm, and a visual line detected from the face image are associated, and an evaluation unit configured to evaluate a visual recognition characteristic of the driver on the basis of the history information.
(2) In the aspect of (1) described above, the alarm control unit may be configured to change the position where the alarm display unit displays the alarm, on the basis of information input by an operation of the driver when there is an abnormality in the evaluated visual recognition characteristic.
(3) In the aspect of (2) described above, the information processing device may further include a passenger detection unit configured to detect a passenger on the vehicle, and a report control unit configured to cause a report unit to perform a report when the position where the alarm is displayed is changed and the passenger is detected.
(4) In the aspect of any one of (1) to (3) described above, the information processing device may further include a notification control unit configured to cause a notification unit to perform a notification when there is an abnormality in the evaluated visual recognition characteristic.
(5) In the aspect of (4) described above, the notification control unit may be configured to cause the notification unit to perform the notification at a timing other than during driving of the vehicle by the driver.
(6) An information processing system according to an aspect of the present invention includes the information processing device of the aspect of (4) or (5) described above, a first terminal device that is used by the driver and is the notification unit, and a second terminal device that is used in a medical institution, in which the notification includes a content regarding a recommendation to receive a medical examination of the medical institution, and the first terminal device causes the second terminal device to perform a notification on the basis of information indicating an intention to accept to receive the medical examination input by the driver.
(7) An information processing system according to an aspect of the present invention includes the information processing device of the aspect of (4) or (5) described above, a first terminal device that is used by the driver and is not the notification unit in which the notification is controlled by the notification control unit, and a second terminal device that is used by a user different from the driver and is the notification unit in which the notification is controlled by the notification control unit, in which the second terminal device causes the first terminal device to perform a notification on the basis of information input by an operation of the user.
(8) An information processing method according to an aspect of the present invention causes a computer to execute processing of detecting a risk object positioned surrounding a vehicle, processing of causing an alarm display unit provided in the vehicle to display an alarm according to a position of the risk object, processing of acquiring a face image of a driver of the vehicle, processing of determining whether the driver is able to recognize the alarm by the alarm display unit, on the basis of a position where the alarm is displayed and information relating to the face image, processing of storing, in a storage unit, history information in which the position where the alarm is displayed, information about whether the driver is able to recognize the alarm, and a visual line detected from the face image are associated, and processing of evaluating a visual recognition characteristic of the driver on the basis of the history information.
(9) A non-transitory computer-readable storage medium according to an aspect of the present invention stores a program causing a computer to execute processing of detecting a risk object positioned surrounding a vehicle, processing of causing an alarm display unit provided in the vehicle to display an alarm according to a position of the risk object, processing of acquiring a face image of a driver of the vehicle, processing of determining whether the driver is able to recognize the alarm by the alarm display unit, on the basis of a position where the alarm is displayed and information relating to the face image, processing of storing, in a storage unit, history information in which the position where the alarm is displayed, information about whether the driver is able to recognize the alarm, and a visual line detected from the face image are associated, and processing of evaluating a visual recognition characteristic of the driver on the basis of the history information.

According to the aspects of the present invention, it is possible to detect visual field narrowing of the driver.

### BRIEF DESCRIPTION OF THE DRAWINGS

FIG. 1 is a diagram showing an example of a configuration and a usage environment of a driving monitoring device including an information processing device according to a first embodiment.

FIG. 2 is a diagram showing an example of the driving monitoring device.

FIG. 3 is a diagram showing an example of an image acquired by the driving monitoring device.

FIG. 4 is a diagram illustrating risk alarm processing that is performed by the driving monitoring device.

FIG. 5 is a diagram showing an example of information that is detected by a detection unit.

FIG. 6 is a diagram showing an example of an alarm that is displayed by an alarm display unit.

FIG. 7 is a diagram illustrating recognition determination processing that is performed by the driving monitoring device.

FIG. 8 is a diagram showing an example of history information.

FIG. 9 is a diagram illustrating abnormality notification processing that is performed by the driving monitoring device.

FIG. 10 is a diagram showing an example of a change of a position of an alarm displayed by the alarm display unit.

FIG. 11 is a diagram illustrating passenger report processing that is performed by the driving monitoring device.

FIG. 12 is a diagram illustrating abnormality notification processing in an information processing system according to a second embodiment.

FIG. 13 is a diagram showing an example of an alarm that is displayed by the alarm display unit.

FIG. 14 is a diagram showing an example of an alarm that is displayed by the alarm display unit.

### DETAILED DESCRIPTION OF THE INVENTION

Hereinafter, an embodiment of an information processing device, an information processing system, an information processing method, and a storage medium of the present invention will be described with reference to the drawings. In the following description, a front direction of a vehicle is referred to as a plus X direction, a rear direction of the vehicle is referred to as a minus X direction, a right direction that is a width direction of the vehicle with respect to the plus X direction is referred to as a plus Y direction, a left direction is referred to as a minus Y direction, and a height direction of the vehicle that is a direction perpendicular to the X direction and the Y direction is referred to as a plus Z direction.

### First Embodiment

### Overall Configuration

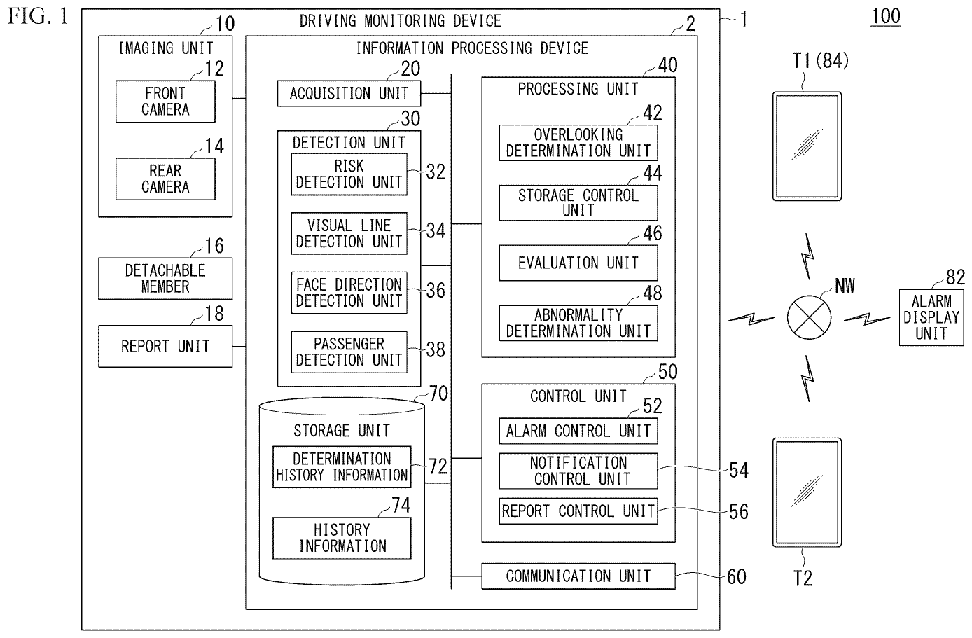

FIG. 1 is a diagram showing an example of a configuration and a usage environment of a driving monitoring device 1 including an information processing device 2 according to a first embodiment. The information processing device 2 is mounted in, for example, the driving monitoring device 1 that is retrofitted to a vehicle (hereinafter, referred to as a “vehicle M”) such as a drive recorder. That is, the driving monitoring device 1 (information processing device 2) is attachable and detachable to and from the vehicle M via a detachable member (hereinafter, referred to as a “detachable member 16”). The information processing device 2 is, for example, a device that is not connected to an in-vehicle network of the vehicle M. The in-vehicle network is an in-vehicle network using a communication standard such as a controller area network (CAN) to which an electronic control unit (ECU) regarding starting, braking, steering of the vehicle M, or vehicle control such as various sensors of the vehicle, operation members regarding driving, and operation buttons is connected. A network of the vehicle M for a human machine interface (HMI) may be excluded from the in-vehicle network.

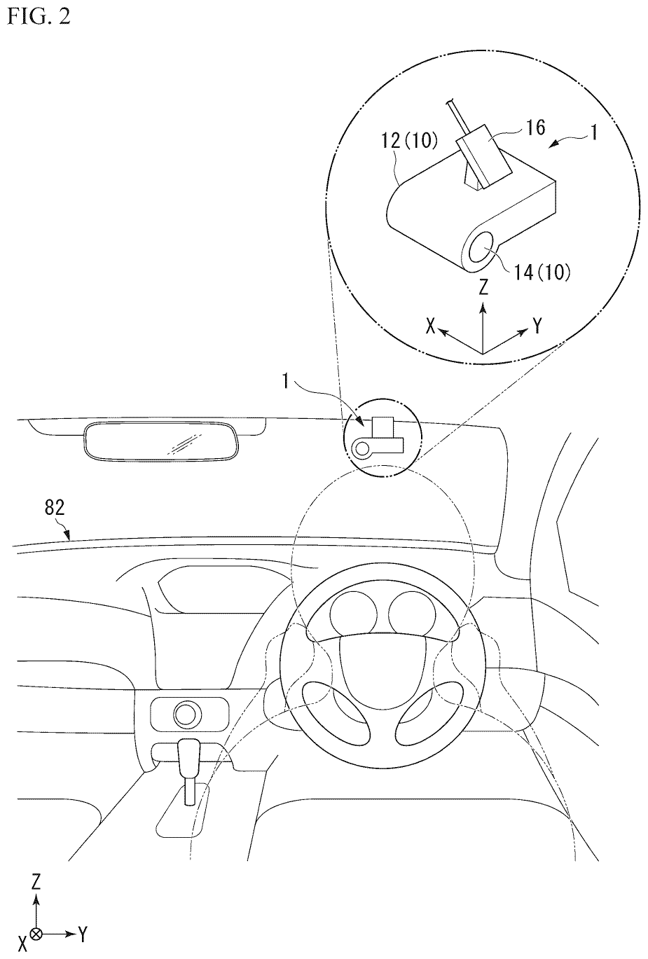

FIG. 2 is a diagram showing an example of the driving monitoring device 1. The driving monitoring device 1 is attached to a position in the vicinity of a front windshield of the vehicle M and near the front of a driver's seat. The driving monitoring device 1 stores an image (video) captured by the imaging unit 10 in, for example, a storage unit 70 (described below). The driving monitoring device 1 includes, for example, a display device such as a liquid crystal display (LCD), and may be configured to display an image (video) stored in the storage unit 70 on the display device.

The driving monitoring device 1 includes, for example, an imaging unit 10, the detachable member 16, a report unit 18, and the information processing device 2. In the example shown in the drawing, the imaging unit 10 includes a front camera 12 and a rear camera 14.

Each of the front camera 12 and the rear camera 14 is, for example, a digital camera using a solid-state imaging element such as a charge coupled device (CCD) or a complementary metal oxide semiconductor (CMOS). The front camera 12 repeatedly (periodically) images the surroundings in front of the vehicle M from a position where the driving monitoring device 1 is attached. The rear camera 14 repeatedly (periodically) images the surroundings behind the vehicle M and the inside of a vehicle cabin of the vehicle M from the position where the driving monitoring device 1 is attached. An angle of view in a horizontal direction at which each of the front camera 12 and the rear camera 14 images is, for example, 180° or more. That is, the driving monitoring device 1 (imaging unit 10) images a range of 360° surrounding the vehicle M from the attached position. Each of the front camera 12 and the rear camera 14 may be, for example, a fisheye camera including a fisheye lens. Alternatively, each of the front camera 12 and the rear camera 14 may be a wide angle camera or the like. In the present embodiment, while a case where the front camera 12 and the rear camera 14 are used will be described, other cameras may be used instead of or in addition to the front camera 12 and the rear camera 14. That is, the imaging unit 10 may be configured such that an image (a surrounding image, a face image, and a vehicle interior image described below) for use in the present embodiment is imaged.

The detachable member 16 is, for example, a member for mounting the driving monitoring device 1 on the vehicle M. The detachable member 16 is any member, for example, a support member such as a sucker, a seal, or a bracket. The detachable member 16 may include a power supply cable (wire or the like) for supplying power to the driving monitoring device 1. The report unit 18 will be described below.

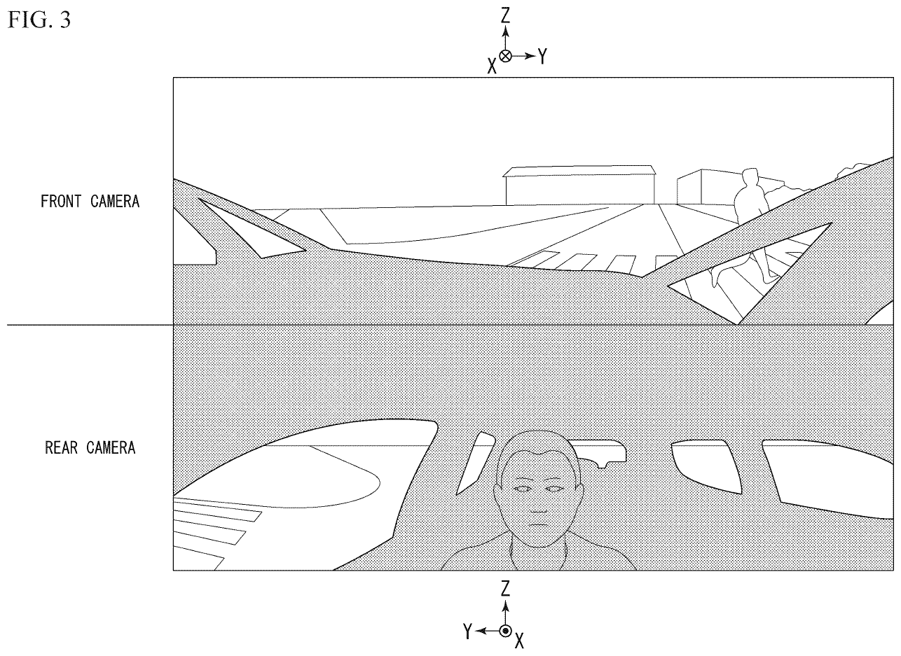

FIG. 3 is a diagram showing an example of an image acquired by the driving monitoring device 1. That is, FIG. 3 is a diagram showing an example of an image captured by the imaging unit 10. The front camera 12 images the front view of the vehicle M over a front windshield, a window on a driver's seat side, and a window on an assistant driver's seat side. The rear camera 14 images the inside (an occupant including a driver) of the vehicle cabin of the vehicle M, the rear view of the vehicle M over the window on the driver's seat side, the window on the assistant driver's seat, and a rear windshield, and the like.

In an image (hereinafter, referred to as a “front image”) captured by the front camera 12, as a subject, for example, the front view of the vehicle M seen through the front windshield such as another vehicle, a pedestrian, a bicycle, a fixed object, a road marking line and an object present on the right and left (front) of the vehicle M seen through the right and left windows are reflected.

In an image (hereinafter, referred to as a “rear image”) captured by the rear camera 14, the inside of the vehicle cabin of the vehicle M, the rear view of the vehicle M seen through the rear windshield, and an object present on the right and left (rear) of the vehicle M seen through the right and left windows are reflected. For this reason, in a rear view captured by the rear camera 14, as a subject, at least the driver of the vehicle M to which the driving monitoring device 1 is attached is reflected.

In the front image and the rear image, an image (hereinafter, referred to as a “surrounding image”) in which a surrounding situation of the vehicle M is imaged is included. In the rear image, an image (hereinafter, referred to as a “face image”) in which the face of the driver of the vehicle M is image is included. In the rear image, an image (hereinafter, referred to as a “vehicle interior image”) obtained by imaging the interior (the inside of the vehicle cabin) of the vehicle M is included. The driving monitoring device 1 may be attached on any place as long as the surrounding image, the face image, and the vehicle interior image can be captured by the imaging unit 10.

The information processing device 2 (see FIG. 1) causes an alarm display unit 82 (see FIG. 2) to output an alarm on the basis of a result of referring to the surrounding image output from the imaging unit 10. The information processing device 2 causes the first terminal device T1 to output a notification on the basis of a result of referring to the face image. In the notification, the content regarding a recommendation to receive a medical examination of a medical institution may be included (details will be described below). The first terminal device T1 causes the second terminal device T2 to perform a notification on the basis of information indicating the intention to accept to receive the medical examination input by the driver of the vehicle M. The driving monitoring device 1, the first terminal device T1, the second terminal device T2, and the alarm display unit 82 may be collectively referred to as an “information processing system 100”.

The driving monitoring device 1, the first terminal device T1, the second terminal device T2, and the alarm display unit 82 are connected in a communicable manner via a network NW. The network NW may be a network using wireless communication or may be a network using wired communication. The network NW may be configured using, for example, the Internet or may be configured using a local area network (LAN), Bluetooth (Registered Trademark), or the like. The network NW may be configured by a combination of a plurality of networks.

The first terminal device T1 is, for example, a portable terminal device such as a smartphone or a tablet terminal that is used by the driver who drives the vehicle M to which the driving monitoring device 1 is attached. In the first terminal device T1, for example, an application for receiving a notification by the information processing device 2 is executed. The application displays an image based on information (for example, notification information described below) transmitted from the information processing device 2 on a display device or causes a speaker to emit sound. The first terminal device T1 is also referred to as a notification unit 84.

A navigation, a display unit, or a speaker of the vehicle M may be used instead of the first terminal device T1. That is, the navigation, the display unit, or the speaker of the vehicle M may output a notification on the basis of an instruction of the information processing device 2. That is, the navigation, the display unit, or the speaker of the vehicle M may be the notification unit 84. A display unit (notification unit 84), a speaker (notification unit 84), or the like may be provided in the driving monitoring device 1 instead of the first terminal device T1.

The second terminal device T2 is a terminal device that is used in a medical institution. The second terminal device T2 may be a terminal that is used by personnel (for example, a physician or a nurse) belonging to the medical institution. The second terminal device T2 is an information processing device that is used by a user different from the driver who uses the first terminal device T1. The second terminal device T2 may be, for example, a smartphone, a tablet terminal, or a personal computer. In the second terminal device T2, for example, an application for receiving a notification by the first terminal device T1 is executed. The application displays an image based on information transmitted from the first terminal device T1 on a display device or causes a speaker to emit sound.

The alarm display unit (alarm display device) 82 displays an alarm under the control of the information processing device 2. That is, the alarm display unit 82 outputs an alarm that can be visually recognized. As shown in FIG. 2, the alarm display unit 82 may be, for example, a bar light provided in the vehicle M. The bar light as the alarm display unit 82 may be disposed, for example, along a lower edge portion of the front windshield. Both end portions of the bar light may be positioned, for example, in both lower corner portions of the front windshield. The alarm display unit 82 includes a communication interface (not shown) for performing wireless communication or wired communication with an information processing device (external device) such as the driving monitoring device 1, the first terminal device T1, or the second terminal device T2 via the network NW (described below).

As shown in FIG. 1, the information processing device 2 includes, for example, an acquisition unit 20, a detection unit 30, a processing unit 40, a control unit 50, a communication unit 60, and a storage unit 70. The detection unit 30 includes a risk detection unit 32, a visual line detection unit 34, a face direction detection unit 36, and a passenger detection unit 38. The processing unit 40 includes a recognition determination unit 42, a storage control unit 44, an evaluation unit 46, and an abnormality determination unit 48. The control unit 50 includes an alarm control unit 52, a notification control unit 54, and a report control unit 56.

For the acquisition unit 20, the detection unit 30, the processing unit 40, and the control unit 50, the function of each component is implemented, for example, by providing a hardware processor such as a central processing unit (CPU) and a storage device (a storage device including a non-transitory storage medium) storing a program (software) and causing the processor to execute the program. Some or all of these components may be implemented by hardware (including a circuit unit; circuitry) such as a large scale integration (LSI), an application specific integrated circuit (ASIC), a field-programmable gate array (FPGA), or a graphics processing unit (GPU) or the function of each component may be implemented by cooperation of software and hardware. For some or all of these components, the function of each component may be implemented by a dedicated LSI.

The program (software) may be stored in advance in the storage device (a storage device including a non-transitory storage medium) (not shown) such as a read only memory (ROM), a random access memory (RAM), or a flash memory in the information processing device 2 or may be stored in a removable storage medium (a non-transitory storage medium) such as a memory card and installed on the storage device when the storage medium is loaded into the driving monitoring device 1. The program (software) may be downloaded from another computer device through short-range communication or wide area communication by the application executed on the first terminal device T1 and/or the second terminal device T2, transmitted from the first terminal device T1 and/or the second terminal device T2, and installed on the storage device.

In the storage unit 70, for example, setting information 72, history information 74, a program (for example, the program described above), and various other kinds of information are stored. The storage unit 70 may be implemented by various storage devices described above, an electrically erasable programmable read only memory (EEPROM), or the like. The communication unit 60 is an interface for performing wireless communication or wired communication with an information processing device (external device) such as the first terminal device T1 or the second terminal device T2, or the alarm display unit 82 via the network NW.

The driving monitoring device 1 (information processing device 2) performs at least risk alarm processing, recognition determination processing, abnormality notification processing, and passenger report processing. The risk alarm processing is processing of detecting a risk object positioned surrounding the vehicle M on the basis of the surrounding image and causing the alarm display unit 82 to display an alarm. The recognition determination processing is processing of determining whether the driver is able to recognize the alarm by the alarm display unit 82. The abnormality notification processing is processing of detecting visual field loss of the driver on the basis of whether the driver is able to recognize the alarm and causing the notification unit 84 to perform a notification. In the abnormality notification processing, processing (alarm position change processing) of changing a position where the alarm display unit 82 displays the alarm, on the basis of an instruction of the driver is also performed. The passenger report processing is processing of causing the report unit 18 to perform a report when the position where the alarm is displayed is changed and a passenger is detected.

The risk object is, for example, an object that the vehicle M should avoid. The risk object is, for example, an object with which the vehicle M interferes or is likely to interfere when moving in the present state. The object with which the vehicle M is likely to interfere is, for example, an object of which a degree of approach is equal to or greater than a predetermined degree after a predetermined time when a position, a moving direction, and a moving speed of an object and a position, a moving method, and a moving speed of the vehicle M are taken into consideration. The risk object may be, for example, an object that approaches the vehicle M from the front. The object may be a traffic participant such as a pedestrian, a bicycle, or a vehicle or may be an object such as an object placed on a road or a fallen object other than the traffic participant. Risk Alarm Processing (when setting information 72 is “normal”)

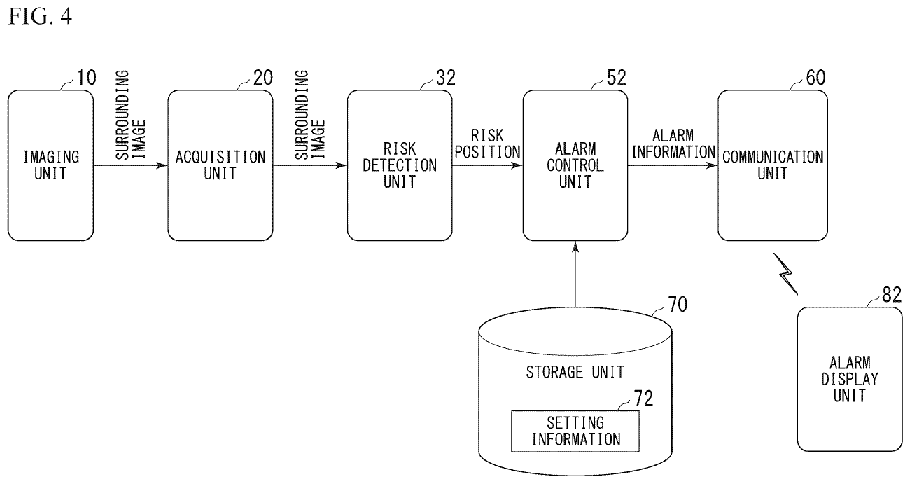

FIG. 4 is a diagram illustrating the risk alarm processing that is performed by the driving monitoring device 1 (information processing device 2).

The acquisition unit 20 acquires a surrounding image from the imaging unit 10. Because the acquisition unit 20 repeatedly (periodically) captures the surrounding image, the acquisition unit 20 repeatedly (periodically) acquires the surrounding image. The acquisition unit 20 may acquire the surrounding image in association with a time (imaging time) when the surrounding image is captured.

The risk detection unit 32 detects a risk object in the surrounding image. “Detecting a risk object” means, for example, detecting the presence of the risk object and a position (hereinafter, referred to as a risk position) of the risk object with respect to the vehicle M (driving monitoring device 1). For example, reference information (not shown) indicating a relationship between a risk position in the surrounding image and a relative position with respect to the vehicle M may be stored in advance in the storage unit 70. The risk detection unit 32 may detect the position of the risk object with respect to the vehicle M on the basis of the reference information.

The risk detection unit 32 detects a presence direction (approach direction) of a risk object with respect to the vehicle M by detecting the relative position of the risk object with respect to the vehicle M. “A presence direction of a risk object” means, for example, the presence direction of the risk object approaching the vehicle M (driving monitoring device 1) with respect to the vehicle M (driving monitoring device 1). Hereinafter, “the presence direction of the risk object” may be referred to as a “risk presence direction”.

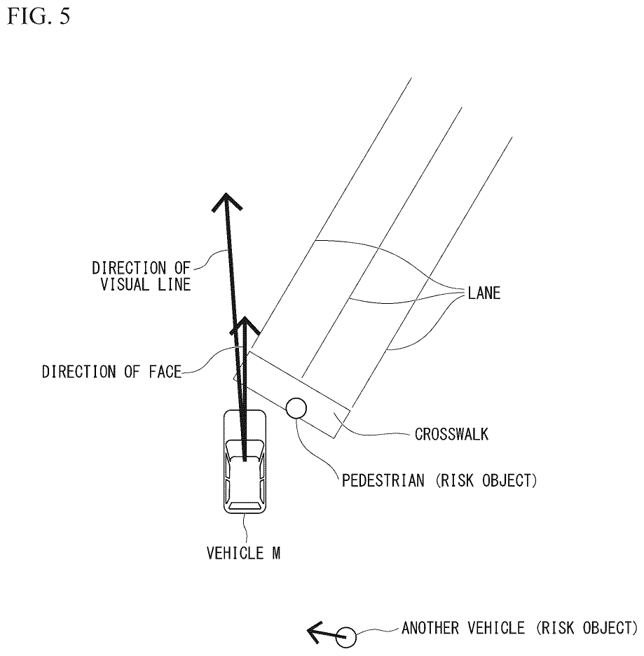

FIG. 5 is a diagram showing an example of information that is detected by the detection unit 30. In the example of FIG. 5, a pedestrian and another vehicle detected by the detection unit 30 are shown with the vehicle M, the direction of the visual line, and the direction of the face as a reference. The pedestrian and another vehicle are an example of a traffic participant (object) that is likely to be a risk object. For information that is detected by the detection unit 30, a traffic participant (object) that is detected by the detection unit 30 and is likely to be a risk object may be shown with the vehicle M, a direction of the vehicle M, and/or a proceeding direction of the vehicle M as a reference instead of the vehicle M, the direction of the visual line, and the direction of the face. In the example of FIG. 5, the direction of the face that is detected in the abnormality notification processing described below is also shown. The detection unit 30 may be configured such that a lane, a crosswalk, or the like can be detected, and in the example of FIG. 5, a lane and a crosswalk detected by the detection unit 30 as also shown.

Returning to FIG. 4, the alarm control unit 52 causes the alarm display unit 82 to display an alarm on the basis of the risk position detected by the risk detection unit 32 and the setting information 72 stored in the storage unit 70. For example, the alarm control unit 52 transmits alarm information to the alarm display unit 82 via the communication unit 60. In the alarm information, for example, information indicating the content of the alarm that should be displayed by the alarm display unit 82 is included. The alarm display unit 82 displays the alarm on the basis of the alarm information.

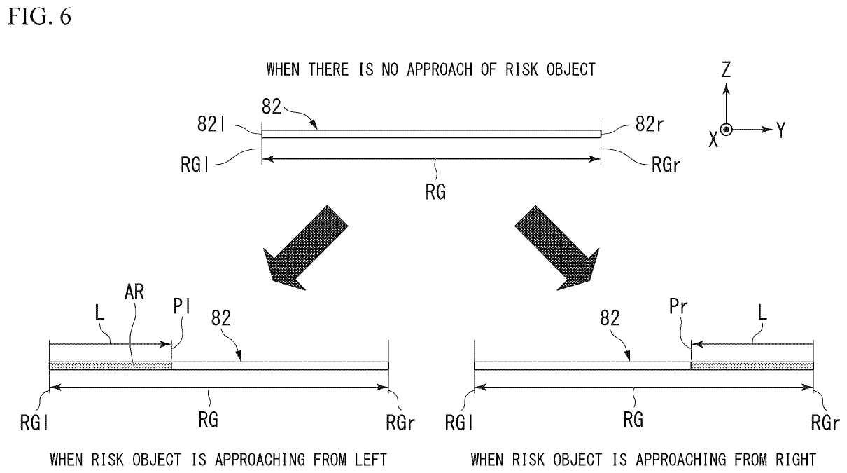

FIG. 6 is a diagram showing an example of an alarm that is displayed by the alarm display unit 82. When a risk object is approaching the vehicle M from the left (front left), the alarm control unit 52 causes, for example, an area positioned on the left side in the alarm display unit 82 to emit light (in FIG. 6, a lower left side). When a risk object is approaching the vehicle M from the right (front right), the alarm control unit 52 causes, for example, an area positioned on the right side in the alarm display unit 82 to emit light (in FIG. 6, lower right). The alarm display unit 82 performs an alarm to the driver through such light emission. Hereinafter, an area in the alarm display unit 82 where light is emitted for an alarm is referred to as a light emission area AR.

Here, in the above-described alarm information, alarm position information indicating a position where the alarm display unit 82 should display an alarm is included. In the example of FIG. 6, the alarm position information may be information for designating the light emission area AR. The alarm control unit 52 may determine, for example, a displayable range RG and a display length L on the basis of the risk position and the setting information 72, and may determine the light emission area AR on the basis of the determined displayable range RG and display length L. Hereinafter, an example of a determination method of the displayable range RG and the display length L, and the light emission area AR based on the displayable range RG and the display length L will be described.

The displayable range RG is a range in which the alarm display unit 82 can display an alarm (that is, the light emission area AR can be positioned). The displayable range RG is determined on the basis of the setting information 72, for example. The setting information 72 is, for example, information that can take a value of “normal” or “special”. The setting information 72 is set to “normal” in advance. When the setting information 72 is “normal”, the alarm control unit 52 determines the displayable range RG such that a left end RGl of the displayable range RG conforms to a left end 82l of the alarm display unit 82, and a right end RGr of the displayable range RG conforms to a right end 82r of the alarm display unit 82. A case where the setting information 72 is “special” will be described along with the abnormality notification processing described below.

When a risk object is approaching the vehicle M from the left (in FIG. 6, lower left), the alarm control unit 52 determines the light emission area AR such that a left end of the light emission area AR conforms to the left end RGl of the displayable range RG, and a right end of the light emission area AR conforms to a position Pl. Here, the position Pl is a position distant right from the left end RGl of the displayable range RG by the display length L. The display length L is determined on the basis of the risk position, for example. For example, as the risk object approaches further toward the vehicle M, the display length L may be determined to be a longer value, and as the risk object becomes more distant from the vehicle M, the display length L may be set to a shorter value. With this, the light emission area AR is determined such that a position of a tip end (right end) varies according to the risk position with the left end RGl of the displayable range RG as a base end (left end). The driver can recognize a degree of approach of the risk object that is approaching from the left, with respect to the vehicle M according to the display length L of the light emission area AR.

When a risk object is approaching the vehicle M from the right (in FIG. 6, lower right), the alarm control unit 52 determines the light emission area AR such that the right end of the light emission area AR conforms to the right end RGr of the displayable range RG, and the left end of the light emission area AR is positioned at a position Pr. Here, the position Pr is a position distant left from the right end RGr of the displayable range RG by the display length L. The display length L may be determined similarly to the above-described method, for example. With this, the light emission area AR is determined such that a position of a tip end (left end) varies according to the risk position with the right end RGr of the displayable range RG as a base end (right end). The driver can recognize a degree of approach of the risk object that is approaching from the right, with respect to the vehicle M according to the display length L of the light emission area AR.

As described above, the alarm control unit 52 causes the alarm display unit 82 to display the alarm according to the position of the risk object and the setting information 72. In the alarm information, information for designating a light emission intensity, a color of light emission, a blinking speed, or the like of the light emission area AR may be included. The alarm control unit 52 may determine the light emission intensity, the color of light emission, the blinking speed, or the like of the light emission area AR according to the position of the risk object, and the like.

The display of the alarm by the display unit 82 may be performed, for example, at a timing (that is, in real time) at which the driver is driving the vehicle M. Examples of “the timing at which the driver is driving the vehicle M” include a timing at which the vehicle M is traveling and a timing at which the vehicle M is temporarily stopped. For example, the transmission of the alarm information by the alarm control unit 52 may be performed at the above-described timing. Alternatively, the transmission of the alarm information by the alarm control unit 52 may be performed at any timing, and the alarm display unit 82 may control the timing of the display of the alarm such that the display of the alarm is performed at the above-described timing.

### Recognition Determination Processing

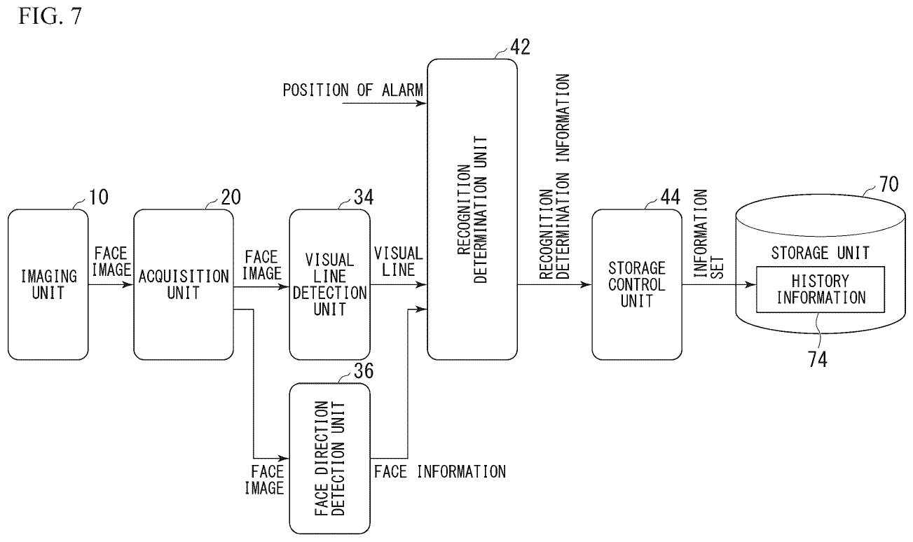

FIG. 7 is a diagram illustrating the recognition determination processing that is performed by the driving monitoring device 1 (information processing device 2).

The acquisition unit 20 acquires the face image from the imaging unit 10. Because the acquisition unit 20 repeatedly (periodically) captures the face image, the acquisition unit 20 repeatedly (periodically) acquires the face image. The acquisition unit 20 may acquire the face image in association with a time (imaging time) when the face image is captured.

The visual line detection unit 34 detects a visual line of the driver in the face image. Specifically, the visual line detection unit 34 detects the visual line of the driver by analyzing the face image using a predetermined image analysis method. “Detecting a visual line” means, for example, detecting a position of an eyeball of the driver and a direction of the visual line (a direction of the eyeball).

The face direction detection unit 36 detects at least a direction of a face of the driver in the face image (also see FIG. 5). Specifically, the face direction detection unit 36 detects the direction of the face of the driver by analyzing the face image using a predetermined image analysis method. The face direction detection unit 36 may detect a position of the face of the driver in addition to the direction of the face of the driver. Hereinafter, information in which “the direction of the face” and “the position of the face” are combined may be referred to as “face information”. The face direction detection unit 36 detects the face information in the face image.

The recognition determination unit 42 determines whether the driver can recognize the alarm, on the basis of the position of the alarm displayed by the alarm display unit 82 and the visual line and/or the face information. Each of the “visual line” and the “face information” is an example of “information relating to a face image”. The recognition determination unit 42 may acquire the position of the alarm, for example, on the basis of the alarm information (alarm position information) output from the alarm control unit 52 in the above-described risk alarm processing.

For example, reference information (not shown) indicating a relationship between the direction of the eyeball (visual line) and/or the direction of the face in the face image and a relative direction with respect to a predetermined direction (for example, a front direction) of the vehicle M may be stored in advance in the storage unit 70. The recognition determination unit 42 may determine whether the direction of the visual line and/or the direction of the face match the position of the alarm, with reference to the reference information. When the direction of the visual line and/or the direction of the face match the position of the alarm, the recognition determination unit 42 may determine that the driver visually recognizes the alarm. “A case where the direction of the visual line and/or the direction of the face match the risk presence direction” may be, for example, a case where the risk object is present on a straight line along the direction of the visual line and/or the direction of the face. Alternatively, “a case where the direction of the visual line and/or the direction of the face match the risk presence direction” may be a case where the risk position is present in a conical area which has a center axis along the direction of the visual line and/or the direction of the face with the position of the visual point (eyeball) and/or the face as a vertex and in which the side spreads toward the front. When the direction of the visual line and/or the direction of the face do not match the position of the alarm, the recognition determination unit 42 may determine that the driver does not visually recognize the alarm.

The recognition determination unit 42 may determine that the driver does not visually recognize the alarm when a state in which the driver does not visually recognize the alarm is continued for a predetermined time or more. The recognition determination unit 42 may determine that the driver visually recognizes the alarm when the driver visually recognizes the alarm or when the state in which the driver does not visually recognize the alarm is eliminated before the predetermined time elapses (that is, when the driver visually recognizes the alarm before the predetermined time elapses, in spite of not visually recognizing the alarm at first). It should be noted that a determination method of recognition by the recognition determination unit 42 is not limited to the above-described method, and can be suitably changed.

The recognition determination unit 42 generates recognition determination information on the basis of the determination result. In the recognition determination information, for example, the presence or absence of the recognition, the position of the alarm, and the visual line described above are included. The above-described determination (the generation of the recognition determination information) by the recognition determination unit 42 may be performed each time the alarm control unit 52 generates the alarm information. In other words, the above-described determination (the generation of the recognition determination information) by the recognition determination unit 42 may be performed each time the alarm display unit 82 displays the alarm.

The storage control unit 44 stores a time and the recognition determination information (the presence or absence of the recognition, the position of the alarm, and the visual line) in the storage unit 70 in association with each other. The time corresponds to, for example, the imaging time of the surrounding image used for the detection of the visual line or a time (display time) when the alarm display unit 82 displays the alarm. The above-described processing (storage processing) by the storage control unit 44 is performed, for example, each time the generation of the recognition determination information by the recognition determination unit 42 is performed. Hereinafter, information that is stored in the storage unit 70 in this manner is referred to as history information 74.

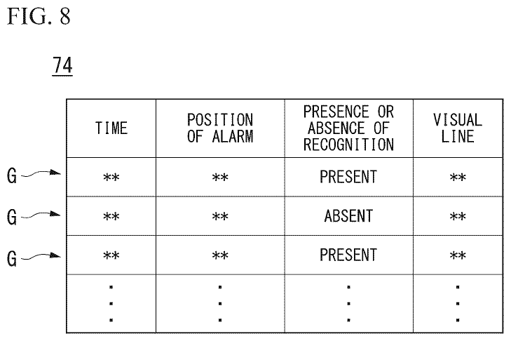

FIG. 8 is a diagram showing an example of the history information 74. The above-described storage processing is repeated by the storage control unit 44, so that a plurality of sets (hereinafter, referred to as an information set G) of information including the time, the position of the alarm, the presence or absence of the recognition, and the visual line are accumulated in the history information 74. That is, the storage control unit 44 generates the information set G each time the generation of the recognition determination information by the recognition determination unit 42 is performed. Then, the storage control unit 44 updates the history information 74 by adding the generated information set G to the history information 74. The history information 74 is used in, for example, the abnormality notification processing described below.

### Abnormality Notification Processing

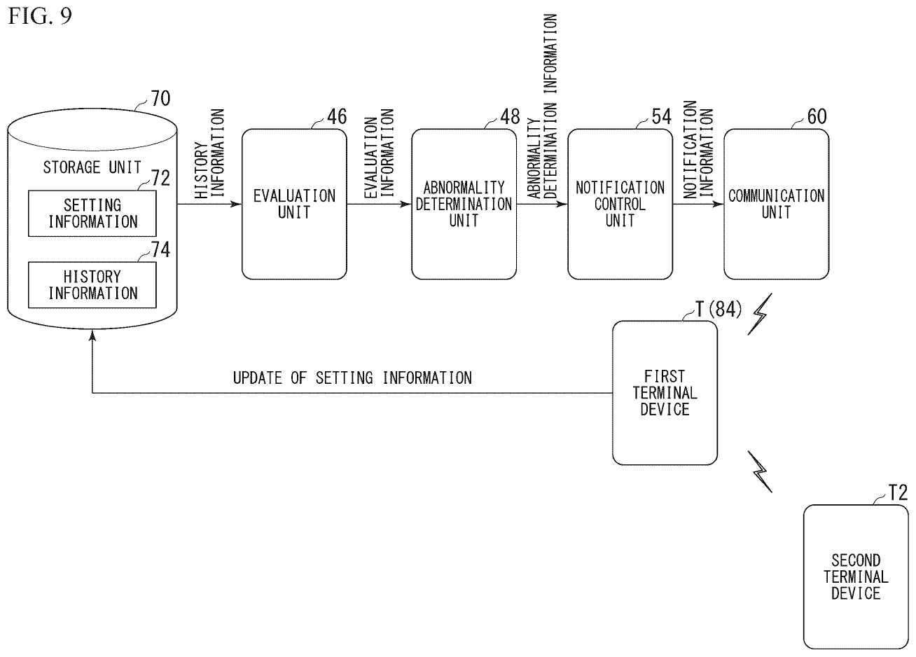

FIG. 9 is a diagram illustrating the abnormality notification processing that is performed by the driving monitoring device 1 (information processing device 2).

The evaluation unit 46 reads the history information 74 from the storage unit 70 and evaluates a visual recognition characteristic of the driver on the basis of the read history information 74. The reading of the history information 74 and the evaluation of the visual recognition characteristic by the evaluation unit 46 may be started, for example, repeatedly in a predetermined cycle, may be started each time the update of the history information 74 by the storage control unit 44 is performed, or may be started by an instruction of the driver or the like. The evaluation unit 46 generates evaluation information as a result of evaluating the visual recognition characteristic of the driver.

The evaluation information may be, for example, information obtained by calculating frequency information relating to a frequency at which the driver can recognize the alarm for each direction (hereinafter, referred to as an in-visual field direction) within the visual field of the driver. In other words, the evaluation information may be map information in which the frequency information and the in-visual field direction of the driver are associated.

For example, the evaluation unit 46 may calculate an alarm vector and a visual line vector for each information set G. The alarm vector is a vector with the position of the eyeball as a start point and the position of the alarm as an end point. The visual line vector is a vector that is directed in the direction of the visual line (eyeball) with the position of the eyeball as a start point and has predetermined magnitude. Then, the evaluation unit 46 may specify an in-visual field direction to which the position of the alarm in the information set G corresponds, by obtaining an angle between the alarm vector and the visual line vector. The frequency information can be calculated for each in-visual field direction by specifying the in-visual field direction for a plurality of information sets G included in the history information 74 and statistically processing the presence or absence of the recognition for each in-visual field direction. The frequency information may be, for example, a recognition rate. The recognition rate may be defined as a value obtained by dividing the number of times the driver visually recognizes the alarm displayed in the in-visual field direction by the total number of times the alarm is displayed in the in-visual field direction.

The abnormality determination unit 48 determines whether there is an abnormality in the visual recognition characteristic of the driver, on the basis of the evaluation information. The abnormality determination unit 48 determines whether there is visual field narrowing (visual field loss) in the driver, for example.

For example, the abnormality determination unit 48 may compare the frequency information evaluated as described above with a predetermined threshold for each in-visual field direction. Then, the abnormality determination unit 48 may determine whether there is an in-visual field direction for which non-recognition of the alarm (overlooking of the alarm) occurs more frequently than the predetermined threshold. The abnormality determination unit 48 may determine that there is an abnormality (visual field narrowing) in the visual recognition characteristic of the driver when there is an in-visual field direction for which the non-recognition of the alarm occurs more frequently than the predetermined threshold. The abnormality determination unit 48 may determine that there is no abnormality (visual field narrowing) in the visual recognition characteristic of the driver when there is no in-visual field direction for which the non-recognition of the alarm occurs more frequently than the predetermined threshold.

The above-described threshold may be set to a different value for each in-visual field direction. Specifically, the threshold may be set such that the recognition rate is reduced from the center of the visual field toward the outside. This is in general because even a healthy person that has no visual field loss declines in vision or attention as a distance from the center of the visual field increases. As the threshold, a value determined in advance on the basis of a visual recognition characteristic of a general healthy person may be used. Alternatively, a value obtained by evaluating the visual recognition characteristic of the driver with the abnormality determination unit 48 may be used as the threshold. In this case, the evaluation unit 46 may store the evaluation information in the storage unit 70 in association with the time, and the abnormality determination unit 48 may perform the above-described abnormality determination by reading the evaluation information stored in the storage unit 70.

The abnormality determination unit 48 generates abnormality determination information on the basis of the above-described determination result. In the abnormality determination information, information indicating the presence or absence of the abnormality (visual field narrowing) in the visual recognition characteristic of the driver is included. In the abnormality determination information, information indicating the in-visual field direction (hereinafter, referred to as a recognition abnormality direction) for which the non-recognition of the alarm occurs more frequently than the predetermined threshold may be included.

The notification control unit 54 causes the first terminal device T1 (notification unit 84) to output a notification on the basis of the abnormality determination information. For example, the notification control unit 54 transmits notification information to the first terminal device T1 (notification unit 84) via the communication unit 60. For example, the notification control unit 54 may transmit the notification information to the first terminal device T1 when information indicating that there is the abnormality (visual field narrowing) in the visual recognition characteristic of the driver is included in the abnormality determination information (that is, when there is the abnormality in the evaluated visual recognition characteristic). When information indicating the recognition abnormality direction is included in the abnormality determination information, information indicating the recognition abnormality direction may be included in the notification information. The notification control unit 54 may not transmit the notification information to the first terminal device T1 when information indicating that there is no abnormality (visual field narrowing) in the visual recognition characteristic of the driver is included in the abnormality determination information (that is, when there is no abnormality in the evaluated visual recognition characteristic).

The first terminal device T1 (notification unit 84) outputs a notification on the basis of the notification information. The notification may be performed, for example, by displaying a character string, an image, or the like based on the notification information on the display device of the first terminal device T1 (notification unit 84). The first terminal device T1 (notification unit 84) may perform a notification indicating that visual field loss occurs or is likely to occur in the driver. When information indicating the recognition abnormality direction is included in the notification information, the first terminal device T1 (notification unit 84) may output contents (for example, a character string or an image) in which the driver or the like can recognize the recognition abnormality direction.

In the notification by the first terminal device T1 (notification unit 84), the content regarding a recommendation to accept to receive a medical examination of a medical institution (for example, a family doctor of the driver) may be included. In this case, the first terminal device T1 (notification unit 84) may cause the driver to input information indicating whether the driver accepts to receive the medical examination of the medical institution. Specifically, a virtual button or the like indicating that the driver accepts to receive the medical examination may be displayed on the display device of the first terminal device T1 (notification unit 84). Such a button or the like functions as an acceptance information acquisition unit that acquires information (hereinafter, referred to as acceptance information) indicating the intention of the driver to accept to receive the medical examination of the medical institution. Then, when the driver operates the first terminal device T1 (notification unit 84), and the acceptance information acquisition unit acquires the acceptance information, the first terminal device T1 (notification unit 84) may cause the second terminal device T2 to perform a notification indicating that the driver accepts to receive the medical examination.

It should be noted that an aspect of notification by the first terminal device T1 (notification unit 84) is not particularly limited as long as the driver can recognize the aspect, and can be suitably changed.

The notification by the first terminal device T1 (notification unit 84) may be performed, for example, at a timing other than the timing at which the driver is driving the vehicle M. Examples of “the timing other than the timing at which the driver is driving the vehicle M” include a timing at which the vehicle M is stopped, a timing after the drivers ends the driving of the vehicle M, and a timing at which the driver is separated from the vehicle M and stays at home. For example, the transmission of the notification information by the notification control unit 54 may be performed at the above-described timing. Alternatively, the transmission of the notification information by the notification control unit 54 may be performed at any timing, and the first terminal device T1 (notification unit 84) may control a timing of notification such that the notification is performed at the above-described timing.

When the driver operates the first terminal device T1 (notification unit 84), and the acceptance information acquisition unit acquires the acceptance information, the first terminal device T1 may update the setting information 72 stored in the storage unit 70 (alarm position change processing). Specifically, the first terminal device T1 may transmit information indicating the effect of changing the setting information 72 to “special”, to the information processing device 2 via the network NW. Then, the information processing device 2 that acquires the above-described information may change (update) the setting information 72 from “normal” to “special”. Alternatively, the first terminal device T1 (notification unit 84) may display a virtual button or the like separate from the acceptance information acquisition unit, and when the button is operated by the driver, the setting information 72 may be updated.

### Risk Alarm Processing (When Setting Information 72 is “Special”)

As described above, in the risk alarm processing, the alarm control unit 52 causes the alarm display unit 82 to display the alarm on the basis of the setting information 72 and the risk position detected by the risk detection unit 32 (see FIG. 4). The setting information 72 is changed to “special” as described above, and accordingly, the position of the alarm that is displayed by the risk alarm processing is changed from when the setting information 72 is “normal”. Hereinafter, the change of the position of the alarm will be described in detail. The processing that is performed by the acquisition unit 20 and the risk detection unit 32 is the same as the processing of FIG. 4, and thus, description will not be repeated.

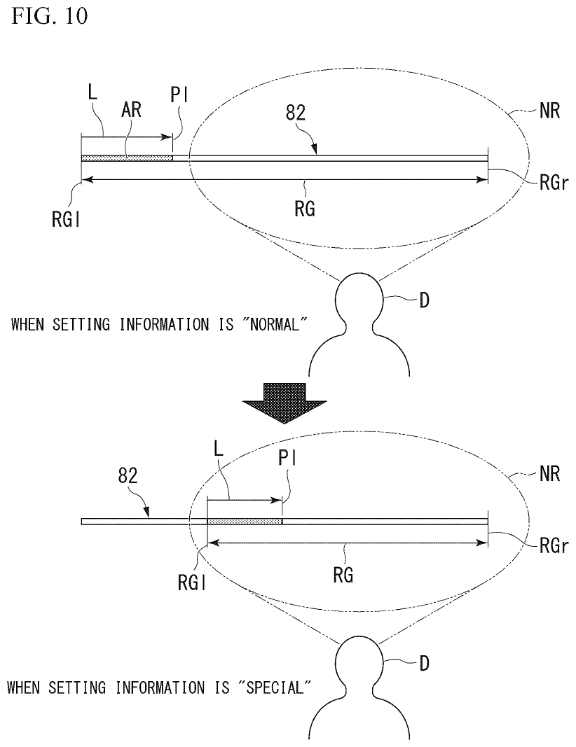

FIG. 10 is a diagram showing an example of the change of the position of the alarm that is displayed by the alarm display unit 82. In FIG. 10, an area shown with reference sign NR is a normal visual field range. The normal visual field range NR is a range in which a driver D can normally recognize an alarm, in a visual field of the driver D (that is, not corresponding to the recognition abnormality direction). As shown in FIG. 10, when the setting information 72 is “normal”, and the displayable range RG is set over the entire alarm display unit 82, the whole or a part of the light emission area AR (alarm) is likely to be positioned outside the normal visual field range NR. In this case, the driver D cannot correctly recognize the display length L of the light emission area AR (alarm).

Therefore, the alarm control unit 52 makes the displayable range RG different between when the setting information 72 is “special” and when the setting information 72 is “normal”. Specifically, the alarm control unit 52 narrows the displayable range RG to a range closer to the driver D (driver's seat) when the setting information 72 is “special”, compared to when the setting information 72 is “normal”. In the example of FIG. 10, the left end RGl of the displayable range RG is positioned closer to the right (that is, the driver's seat side), so that the displayable range RG is narrowed. The displayable range RG is changed in this way, and accordingly, the position (that is, the position where the alarm is displayed) of the light emission area AR is also changed.

For example, when the setting information 72 is “special”, the alarm control unit 52 may determine the displayable range RG to be positioned within the normal visual field range NR. The alarm control unit 52 may estimate the normal visual field range NR on the basis of the evaluation information generated by the evaluation unit 46, and the like, for example. Then, the alarm control unit 52 may determine the displayable range RG to be positioned within the normal visual field range NR. With this, the light emission area AR (alarm) is also positioned within the normal visual field range NR. In this way, the displayable range RG is narrowed to the driver D side (for example, the displayable range RG is positioned within the normal visual field range NR), and accordingly, the driver D who has visual field narrowing can be normally recognize the alarm.

### Passenger Report Processing

When the setting information 72 is changed to “special” by the driver, the position of the alarm that is displayed by the alarm display unit 82 is changed as described above, while a passenger who sees the alarm displayed at the changed position may feel discomfort. For this reason, when the position of the alarm is changed, the driving monitoring device 1 (information processing device 2) performs passenger report processing of reporting the effect to the passenger.

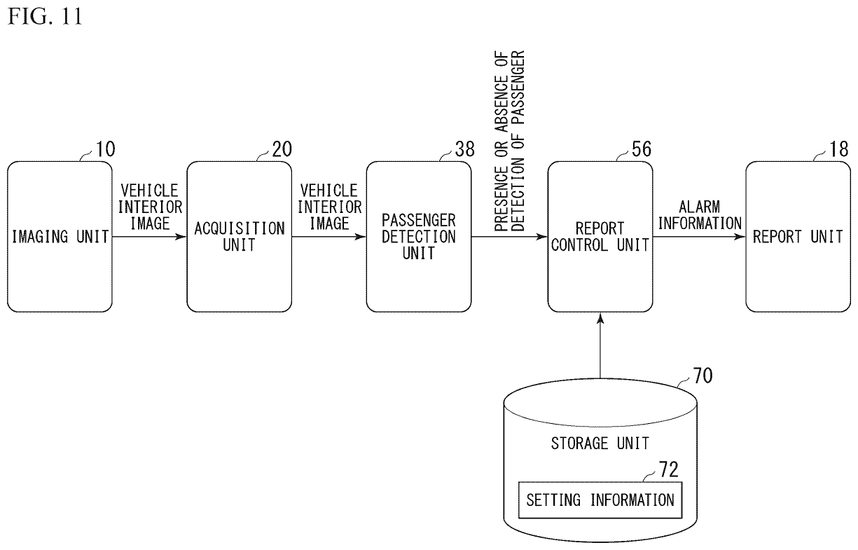

FIG. 11 is a diagram illustrating the passenger report processing that is performed by the driving monitoring device 1 (information processing device 2).

The acquisition unit 20 acquires the vehicle interior image from the imaging unit 10. Because the acquisition unit 20 repeatedly (periodically) captures the vehicle interior image, the acquisition unit 20 repeatedly (periodically) acquires the vehicle interior image.

The passenger detection unit 38 detects a passenger in the vehicle interior image. The passenger is personnel that is on the vehicle M and is personnel who are not the driver. Specifically, the passenger detection unit 38 detects a passenger by analyzing the vehicle interior image using a predetermined image analysis method. “Detecting a passenger” means, for example, detecting the presence of passenger.

The report control unit 56 causes the report unit 18 to perform a report on the basis of the presence or absence of the detection of the passenger by the passenger detection unit 38 and the setting information 72 stored in the storage unit 70. Specifically, when the setting information 72 is “special” (that is, the position where the alarm is displayed is changed), and a passenger is detected by the passenger detection unit 38, the report control unit 56 causes the report unit 18 to perform a report. The report control unit 56 may not cause the report unit 18 not to perform a report until a passenger is newly detected by the passenger detection unit 38 after the report unit 18 is caused to perform a report once.

The report unit 18 performs a report under the control of the report control unit 56. The report unit 18 is, for example, a speaker or a display device. For example, the report unit 18 performs a report with a character string, an image, sound, or the like under the report control unit 56. In the report by the report unit 18, the content informing the effect that the position where the alarm is displayed is changed may be included.

According to the first embodiment described above, the information processing device 2 includes the risk detection unit 32 that detects the risk object positioned surrounding the vehicle M, the alarm control unit 52 that causes the alarm display unit 82 provided in the vehicle M to display the alarm according to the position of the risk object, the acquisition unit 20 that acquires the face image of the driver of the vehicle M, the recognition determination unit 42 that determines whether the driver is able to recognize the alarm by the alarm control unit 52, on the basis of the position where the alarm is displayed and information relating to the face image, the storage control unit 44 that stores, in the storage unit 70, the history information 74 in which the position where the alarm is displayed, information about whether the driver is able to recognize the alarm, and the visual line detected from the face image are associated, and the evaluation unit 46 that evaluates the visual recognition characteristic of the driver on the basis of the history information 74. With this, it is possible to detect visual field narrowing of the driver.

### Second Embodiment

Next, while a second embodiment will be described, a basic configuration is similar to the first embodiment. For this reason, similar configurations are represented by the same reference numbers, and description thereof will not be repeated. Only differences will be described.

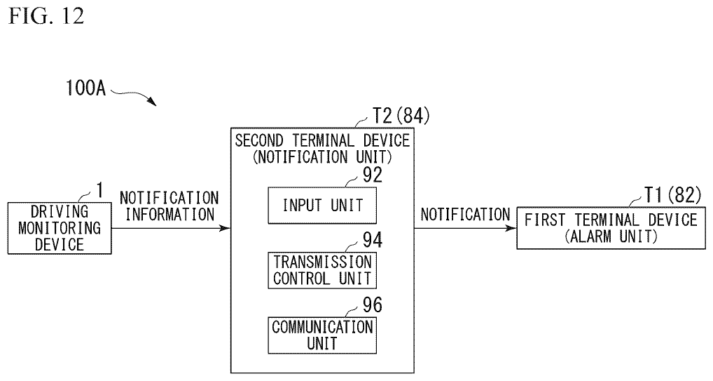

FIG. 12 is a diagram illustrating abnormality notification processing in an information processing system 100A according to the second embodiment. Similarly to the first embodiment, a second terminal device T2 in the second embodiment may be a terminal device that is used in a medical institution. Alternatively, the second terminal device T2 in the second embodiment may be an information processing device that is used by a staff member of an insurance company, or the like. The second terminal device T2 may be an information processing device that is used by a user different from the driver.

In the second embodiment, the driving monitoring device 1 (notification control unit 54) transmits the notification information to the second terminal device T2, not to the first terminal device T1. That is, in the second embodiment, the notification unit 84 in which the notification is controlled by the notification control unit 54 is the second terminal device T2, not the first terminal device T1. In the second terminal device T2, for example, an application for receiving the notification by the information processing device 2 is executed. The application displays an image, a character string, or the like based on information (notification information or the like) transmitted from the information processing device 2 on the display device or causes a speaker to emit sound.

The second terminal device T2 causes the first terminal device T1 to perform a notification on the basis of information input by an operation of the user. The second terminal device T2 includes, for example, an input unit 92, a transmission control unit 94, and a communication unit 96.

For the input unit 92 and the transmission control unit 94, the function of each component is implemented, for example, by providing a hardware processor such as a CPU and a storage device (a storage device including a non-transitory storage medium) storing a program (software) and causing the processor to execute the program. Some or all of these components may be implemented by hardware (including a circuit unit) such as an LSI, an ASIC, an FPGA, or a GPU or the function of each component may be implemented by cooperation of software and hardware. For some or all of these components, the function of each component may be implemented by a dedicated LSI. The communication unit 96 is an interface for performing wireless communication or wired communication with an information processing device such as the information processing device 2 or the first terminal device T1 via the network NW.

The input unit 92 receives an operation of the user and inputs the operation to the second terminal device T2. The input unit 92 is configured using existing input devices such as a keyboard, a pointing device (a mouse, a tablet, or the like), a button, and a touch panel. The input unit 92 may be an interface for connecting an input device to the second terminal device T2. In this case, the input unit 92 inputs an input signal generated according to an operation of the user on the input device to the second terminal device T2. The input unit 92 may have any configuration as long as a configuration is made in which an instruction based on an operation of the user can be input to the second terminal device T2.

For example, the user confirms the content of the notification from the second terminal device T2 caused by the driving monitoring device 1 (notification control unit 54), and examines the content that should be notified to the driver. The content to be notified to the driver is, for example, a recommendation of a medical examination of a medical institution for finding out the possibility of visual field narrowing or visual field narrowing. The user inputs information including the examined notification content to the second terminal device T2 by operating the input unit 92. The transmission control unit 94 transmits information input by the operation of the user to the first terminal device T1 via the communication unit 96. The first terminal device T1 performs a notification to the driver on the basis of the transmitted information.

The information processing system 100A may be configured to regulate the transmission of the notification information to the second terminal device T2 by the driving monitoring device 1 (notification control unit 54) according to an operation of the driver on the first terminal device T1 or the driving monitoring device 1. For example, regulation information indicating the presence or absence of regulation of the transmission of the notification information may be generated according to an operation of the driver on the first terminal device T1 or the driving monitoring device 1, and the generated regulation information may be stored in the storage unit 70. Then, the alarm control unit 52 may determine whether to transmit the notification information to the second terminal device T2, on the basis of the regulation information stored in the storage unit 70. According to such a configuration, determination regarding whether to inform the user who uses the second terminal device T2 of information relating to an abnormality of the driver is performed according to the intention of the driver. Accordingly, the privacy of the driver is easily protected.

According to the second embodiment described above, the information processing system 100A includes the information processing device 2, the first terminal device T1 that is used by the driver and is not the notification unit 84 in which the notification is controlled by the notification control unit 54, and the second terminal device T2 that is used by the user different from the driver and is the notification unit 84 in which the notification is controlled by the notification control unit 54, and the second terminal device T2 causes the first terminal device T1 to perform the notification on the basis of information input by the operation of the user. With this, the notification content examined by the user who uses the second terminal device T2 can be provided to the driver who uses the first terminal device T1.

### Third Embodiment

Next, while a third embodiment will be described, a basic configuration is similar to the first embodiment. For this reason, similar configurations are represented by the same reference numbers, and description thereof will not be repeated. Only differences will be described.

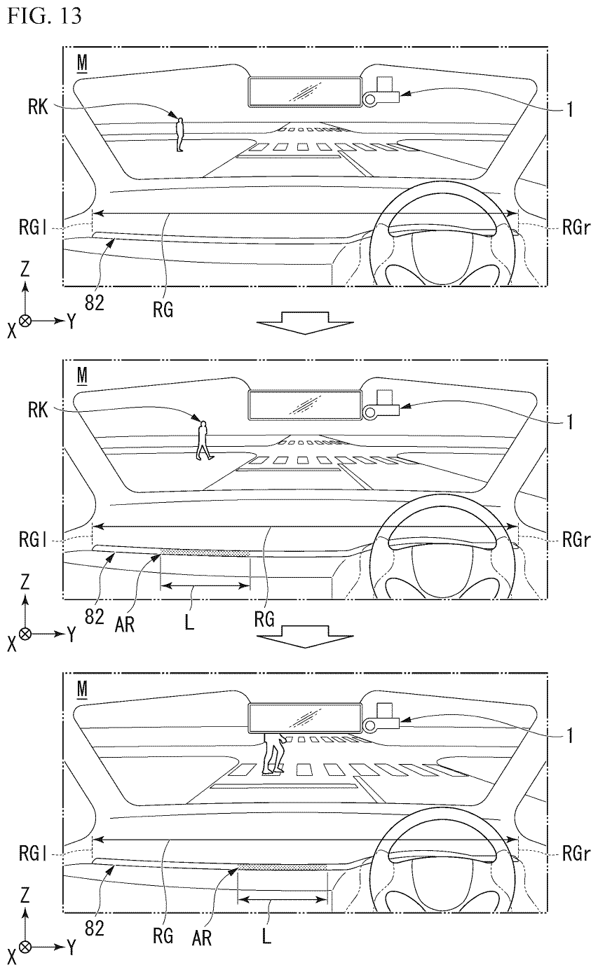

FIG. 13 is a diagram showing an example of an alarm that is displayed by the alarm display unit 82. The example shown in FIG. 13 corresponds to when the setting information 72 is “normal”. In the example shown in FIG. 6, in the light emission area AR, the position (position Pl, Pr) of the tip end varies according to the risk position with the left end RGl of the displayable range RG (that is, the left end of the alarm display unit 82) or the right end RGr of the displayable range (that is, the right end of the alarm display unit 82) as a base end. In the example shown in FIG. 13, that is, in the example according to the third embodiment, a shape of the light emission area AR is different from in the example shown in FIG. 6, that is, the example according to the first embodiment. With this, in the example shown in FIG. 13, the end portion of the light emission area AR does not necessarily conform to the left end RGl of the displayable range RG (that is, the left end of the alarm display unit 82) or the right end RGr of the displayable range (that is, the right end of the alarm display unit 82). Hereinafter, description will be specifically provided.

In an upper diagram of FIG. 13, a pedestrian as a risk object RK is at a position sufficiently distant from the vehicle M, and the alarm display unit 82 does not emit light. In a middle diagram of FIG. 13, the risk object RK approaches the vehicle M, and a part of the alarm display unit 82 emits light. Here, the alarm control unit 52 changes the position of the light emission area AR according to the position (the risk object RK with respect to the vehicle M) of the risk object RK. With this, in a lower diagram of FIG. 13, as the risk object RK moves to the right, the position of the light emission area AR also moves to the right. The display length L of the light emission area AR may be, for example, constant regardless of the position of the light emission area AR.

Though not shown in detail, similarly to the first embodiment, when the setting information 72 is “special”, the alarm control unit 52 narrows the displayable range RG to a narrow closer to the driver's seat. Specifically, the alarm control unit 52 may determine the displayable range RG to be positioned within the normal visual field range NR (also see FIG. 10). Then, the alarm control unit 52 may change the position of the light emission area AR within the displayable range RG narrowed in this way. With this, the operation and effects similar to the first embodiment are obtained. That is, it is possible for the driver who has visual field narrowing to normally recognize the alarm.

### Modification Examples

The technical scope of the present invention is not limited to the above-described embodiments, and various changes may be made without departing from the spirit of the present invention.

For example, in each embodiment described above, when the risk object satisfies a predetermined condition, the alarm control unit 52 may cause the alarm display unit 82 to display an alarm in a more emphasized aspect compared to when the risk object does not satisfy the predetermined condition. The “aspect in a more emphasized aspect” is also referred to as a warning. The predetermined condition may be, for example, when the risk object approaches the vehicle M fast. The predetermined condition may be, for example, a condition based on a speed (for example, a relative speed with respect to the vehicle M) of the risk object and a relative position of the risk object with respect to the vehicle M. The predetermined condition may be, for example, a condition that the relative speed of the risk object with respect to the vehicle M is equal to or higher than a threshold, a condition that a relative distance of the risk object with respect to the vehicle M is less than a threshold, or a combination of these conditions.

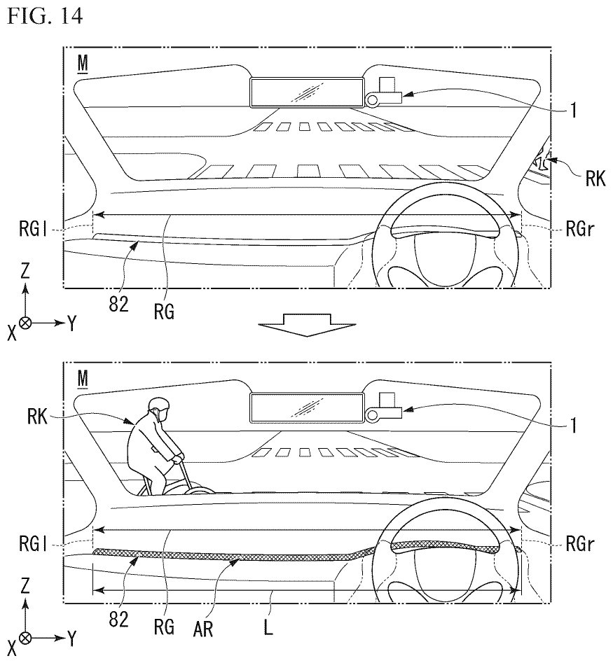

FIG. 14 is a diagram showing an example of an alarm that is displayed by the alarm display unit 82. In an upper diagram of FIG. 14, a pedestrian as a risk object RK has passed to the right, and the alarm display unit 82 ends light emission. Thereafter, in a lower diagram of FIG. 14, a person (new risk object RK) on a bicycle suddenly appears from the side of the vehicle M. Accordingly, the alarm control unit 52 causes the alarm display unit 82 to emit light from the entire alarm display unit 82 (displayable range RG), and changes the color of light emission of the alarm display unit 82. Causing the entire alarm display unit 82 (displayable range RG) to emit light and changing the color of light emission of the alarm display unit 82 are an example of an “alarm in a more emphasized aspect”. For example, when the color of light emission of the alarm display unit 82 when the predetermined condition is not satisfied is yellow or the like, the color of light emission when the predetermined condition is satisfied may be red or the like. When the risk object satisfies the predetermined condition, the alarm control unit 52 may cause the alarm display unit 82 to display the alarm in the more emphasized aspect as described above regardless of whether the setting information 72 is “normal” or “special”.

The alarm display unit 82 is not limited to the bar light, and may be the display device provided in the vehicle M, or the like. The type of the alarm display unit 82 can be suitably changed as long as a device is provided in front of the driver's seat and can display an alarm. Also such an alarm display unit 82, the operation and effects similar to the above-described embodiments can be obtained by changing a position where an alarm is displayed, by the alarm control unit 52. The alarm display unit 82 may be a device that is retrofitted to the vehicle M or may be incorporated in the vehicle M in advance.

In the above-described embodiments, while the risk detection unit 32 detects a risk object through image analysis on the surrounding image, the configuration of the risk detection unit 32 is not limited thereto. For example, various sensors provided in the vehicle M or the like, or an ECU of the vehicle M that manages these sensors may be connected to the network NW, and the risk detection unit 32 may detect a risk object on the basis of signals output from these sensors. Examples of the sensors include a radar device and a light detection and ranging (LIDAR). A detection method of a risk object in the risk detection unit 32 is not limited to these examples, and can be suitably changed.

In the above-described embodiments, while the passenger detection unit 38 detects a passenger through image analysis on the vehicle interior image, the configuration of the passenger detection unit 38 is not limited thereto. For example, various sensors provided in the vehicle M or the like, or an ECU of the vehicle M that manages these sensors may be connected to the network NW, and the passenger detection unit 38 may detect a passenger on the basis of signals output from these sensors. Examples of the sensors include a thermosensor and a weight sensor provided in each seat of the vehicle M. A detection method of a passenger in the passenger detection unit 38 is not limited to these examples, and can be suitably changed.

The driving monitoring device 1 (information processing device 2) may perform another alarm processing (hereinafter, referred to as auxiliary alarm processing) of performing an alarm according to the risk position in addition to (or instead of) the above-described risk alarm processing. The auxiliary alarm processing may be, for example, overlooking alarm processing. The overlooking alarm processing is processing of detecting overlooking of the risk object by the driver on the basis of the risk position and information (for example, the visual line or the face information) relating to the face image, and causing the alarm display unit 82 to display an alarm. Similarly to the risk alarm processing, the auxiliary alarm processing may be performed at a timing (that is, in real time) at which the driver is driving the vehicle M. When the auxiliary alarm processing is performed, the above-described recognition determination processing may include processing of determining whether the driver can recognize the alarm displayed in the auxiliary alarm processing. The above-described alarm position change processing may include processing of changing the position of the alarm that is displayed in the auxiliary alarm processing.

In the information processing systems 100 and 100A according to the above-described embodiments, the driving monitoring device 1 (notification control unit 54) may transmit the notification information to both the first terminal device T1 and the second terminal device T2. In other words, both the first terminal device T1 and the second terminal device T2 may be the notification unit 84 in which the notification is controlled by the notification control unit 54. When the alarm display unit 82 includes a display device, or the like, the alarm display unit 82 may function as the notification unit 84.

In the first embodiment, the driving monitoring device 1 (information processing device 2) and the first terminal device T1 are configured as different devices, but may be configured as an integrated device. For example, all the functions of the imaging unit 10, the acquisition unit 20, the detection unit 30, the processing unit 40, the control unit 50, the storage unit 70, and the notification unit 84 may be mounted in the driving monitoring device 1. Alternatively, all these functions may be mounted in the first terminal device T1 or the vehicle M. Also in the second embodiment, similarly, all the functions of the imaging unit 10, the acquisition unit 20, the detection unit 30, the processing unit 40, the control unit 50, and the storage unit 70 may be mounted in the driving monitoring device 1 or all these functions may be mounted in the first terminal device T1. A camera other than the camera in the driving monitoring device 1 may be allowed to have a part or all of the functions of the imaging unit 10. For example, a driver monitor camera that images the driver may capture the face image.

The driving monitoring device 1 may be mounted using a plurality of information processing devices. For example, the functions of the information processing device 2 may be mounted in the first terminal device T1 or the vehicle M (for example, the ECU). Alternatively, the driving monitoring device 1 may be mounted using a device such as a cloud. For example, in the driving monitoring device 1, the detection unit 30, the processing unit 40, the control unit 50, and the storage unit 70 may be mounted in different information processing devices. For example, the storage unit 70 may be distributed and mounted in a plurality of information processing devices.

The embodiments and the modification examples described above can be expressed as follows.

An information processing device including
a storage medium that stores computer-readable instructions, and
a processor connected to the storage medium,
in which the processor executes the computer-readable instructions to
detect a risk object positioned surrounding a vehicle,
cause an alarm display unit provided in the vehicle to display an alarm according to a position of the risk object,
acquire a face image of a driver of the vehicle,
determine whether the driver is able to recognize the alarm by the alarm display unit, on the basis of a position where the alarm is displayed and information relating to the face image,
store, in a storage unit, history information in which the position where the alarm is displayed, information about whether the driver is able to recognize the alarm, and a visual line detected from the face image are associated, and
evaluate a visual recognition characteristic of the driver on the basis of the history information.

The components in the embodiments described above can be appropriately replaced with well-known components without departing from the spirit of the present invention, and the embodiments and the modification examples described above may be appropriately combined.

What is claimed is:

1. An information processing device comprising:
a risk detection unit configured to detect a risk object positioned surrounding a vehicle;
an alarm control unit configured to cause an alarm display unit provided in the vehicle to display an alarm according to a position of the risk object;
an acquisition unit configured to acquire a face image of a driver of the vehicle;
a recognition determination unit configured to determine whether the driver is able to recognize the alarm by the alarm display unit, on the basis of a position where the alarm is displayed and information relating to the face image;
a storage control unit configured to store, in a storage unit, history information in which the position where the alarm is displayed, information about whether the driver is able to recognize the alarm, and a visual line detected from the face image are associated; and
an evaluation unit configured to evaluate a visual recognition characteristic of the driver on the basis of the history information.

2. The information processing device according to claim 1,
wherein the alarm control unit is configured to change the position where the alarm display unit displays the alarm, on the basis of information input by an operation of the driver when there is an abnormality in the evaluated visual recognition characteristic.

3. The information processing device according to claim 2, further comprising:
a passenger detection unit configured to detect a passenger on the vehicle; and
a report control unit configured to cause a report unit to perform a report when the position where the alarm is displayed is changed and the passenger is detected.

4. The information processing device according to claim 1, further comprising:
a notification control unit configured to cause a notification unit to perform a notification when there is an abnormality in the evaluated visual recognition characteristic.

5. The information processing device according to claim 4,
wherein the notification control unit is configured to cause the notification unit to perform the notification at a timing other than during driving of the vehicle by the driver.

6. An information processing system comprising:
the information processing device according to claim 4;
a first terminal device that is used by the driver and is the notification unit; and
a second terminal device that is used in a medical institution,
wherein the notification includes a content regarding a recommendation to receive a medical examination of the medical institution, and
the first terminal device causes the second terminal device to perform a notification on the basis of information indicating an intention to accept to receive the medical examination input by the driver.

7. An information processing system comprising:
the information processing device according to claim 4;
a first terminal device that is used by the driver and is not the notification unit in which the notification is controlled by the notification control unit; and
a second terminal device that is used by a user different from the driver and is the notification unit in which the notification is controlled by the notification control unit,
wherein the second terminal device causes the first terminal device to perform a notification on the basis of information input by an operation of the user.

8. An information processing method causing a computer to execute:
processing of detecting a risk object positioned surrounding a vehicle;
processing of causing an alarm display unit provided in the vehicle to display an alarm according to a position of the risk object;
processing of acquiring a face image of a driver of the vehicle;
processing of determining whether the driver is able to recognize the alarm by the alarm display unit, on the basis of a position where the alarm is displayed and information relating to the face image;
processing of storing, in a storage unit, history information in which the position where the alarm is displayed, information about whether the driver is able to recognize the alarm, and a visual line detected from the face image are associated;
processing of evaluating a visual recognition characteristic of the driver on the basis of the history information.

9. A non-transitory computer-readable storage medium storing a program causing a computer to execute:
processing of detecting a risk object positioned surrounding a vehicle;
processing of causing an alarm display unit provided in the vehicle to display an alarm according to a position of the risk object;
processing of acquiring a face image of a driver of the vehicle;
processing of determining whether the driver is able to recognize the alarm by the alarm display unit, on the basis of a position where the alarm is displayed and information relating to the face image;
processing of storing, in a storage unit, history information in which the position where the alarm is displayed, information about whether the driver is able to recognize the alarm, and a visual line detected from the face image are associated; and
processing of evaluating a visual recognition characteristic of the driver on the basis of the history information.
